(19) United States
(12) Patent Application Publication
(10) Pub. No.: US 2015/0293573 A1
(43) Pub. Date: Oct. 15, 2015

(54) Power Outage Entertainment System

(71) Applicant: Angelita Howard, Chicago, IL (US)

(72) Inventor: Angelita Howard, Chicago, IL (US)

(21) Appl. No.: 14/687,256

(22) Filed: Apr. 15, 2015

Related U.S. Application Data
(60) Provisional application No. 61/979,609, filed on Apr. 15, 2014.

(51) Int. Cl. G06F 1/30; H04N 5/38

(52) U.S. Cl. CPC G06F 1/30; H04N 5/38

(57) ABSTRACT

A kayak that collapses to form a backpack structure is provided. The kayak includes a plurality of removably connectable hull members. The hull members include at least a middle section, a front section, and a rear section. The middle section comprises a tapered complex body having a cavity. The tapered complex body has a width larger than width of the front section and rear section such that the tapered complex body can receive the front section and the rear section in the cavity of the middle section. A plurality of bolts are configured to removably connect the hull members. The bolts provide pressure to a rubber gasket for connecting the front section and the rear section to the middle section. A cockpit is formed by removably connecting the front section and rear section to the middle section via the bolts. A seat member is removably attached to the cockpit.

### CROSS REFERENCE TO RELATED APPLICATION

This application claims the benefit of U.S. Provisional Application No. 61/979,609 filed on Apr. 15, 2014. The above identified patent application is herein incorporated by reference in its entirety to provide continuity of disclosure.

### BACKGROUND OF THE INVENTION

1. Field of the Invention

The present invention relates to entertainment devices and battery backup systems for the same. More specifically, the present invention relates to a battery-powered entertainment system for use during a power outage, whereby a battery pack and a media player is provided for powering a television and the media player for in-home entertainment in the absence of domestic power.

While not a necessity during a power outage, entertainment devices are a welcome distraction during prolonged blackouts or gaps in domestic electrical power. Many homeowners employ backup systems to run appliances in the home during such outages, particularly during the hotter or colder months when the home can change temperature drastically and food can begin to spoil. The typical backup system includes a gas-powered generator that supplies sufficient power to run many appliances. However, generators are generally reserved for necessities such as the refrigerator and climate control appliances. The present invention, by contrast, pertains to a system that provides entertainment media during a power outage, and furthermore one that provides a battery power pack that can power a television and media device for a period of time without domestic power.

Typical televisions consume a considerable amount of electrical energy during operation. However, more modern LED and LCD televisions have lower power requirements than older technologies. Still other television technologies are optimized for lower power consumption, as most consumers are conscious of energy expenditure when purchasing a new television. Existing regulation even requires an “Energy Guide” to be placed on television boxes prior to purchase, which lists the estimated cost per year based on average energy costs and an average daily usage. Therefore, modern televisions make it feasible to employ battery powered system that can power a flat panel television and an associated media player for several hours during a blackout. The present invention provides such a system.

Specifically, the present invention comprises a battery backup for a television that is ideal for LED, LCD, and efficient plasma screen televisions of moderate size. The backup assembly includes a battery pack with a plurality of batteries that are arranged to meet the power demands of the television and simultaneously power a media system connected thereto. In particular, the system powers an optical drive and supporting electronics to transmit a signal from the optical drive to the television when displaying movies, all without outlet power. When power is available from the outlet, the system recharges the batteries such that the battery pack remains viable and charged in a subsequent outage. The end result is an entertainment device that allows watching movies and listening to music using the backup assembly and an available television that matches the power rating of the backup assembly.

### SUMMARY OF THE INVENTION

The following summary is intended solely for the benefit of the reader and is not intended to be limiting in any way. The present invention provides a new media system that can be utilized for providing convenience for the user during a power outage and when television entertainment is desired.

It is therefore an object of the present invention to provide a new and improved battery-powered media device that has all of the advantages of the prior art and none of the disadvantages.

It is another object of the present invention to provide a battery-powered media device that includes a battery pack sufficient to power currently available flat panel television of moderate size and power rating, whereby the battery pack can provide sufficient electrical power to operate the television for several hours during a power outage.

Another object of the present invention is to provide a battery-powered media device that includes an optical drive for displaying and projecting media from a connected television.

Yet another object of the present invention is to provide a battery-powered media device that includes a battery pack that is rechargeable with domestic power, and one that can be removed and interchanged during a blackout when one battery pack has discharged and a replacement is necessary.

Another object of the present invention is to provide a battery-powered media device that includes an inverter and low voltage connections to send electrical power to the television, and to send audio and visual signals to the television when the television is powered.

Another object of the present invention is to provide a battery-powered media device that can operate as a standard media player in connection with the television when domestic power is available.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of an exemplary embodiment of the present invention.

FIG. 2 shows an internal overhead view of the media system of the present invention.

FIG. 3 shows a rear view of an exemplary embodiment of the media system of the present invention.

### DETAILED DESCRIPTION OF THE INVENTION

Reference is made herein to the attached drawings. Like reference numerals are used throughout the drawings to depict like or similar elements of the media system of the present invention. For the purposes of presenting a brief and clear description of the present invention, the preferred embodiment will be discussed as used for powering a television during a blackout and for transmitting media to the television without using domestic power. The figures are intended for representative purposes only and should not be considered to be limiting in any respect.

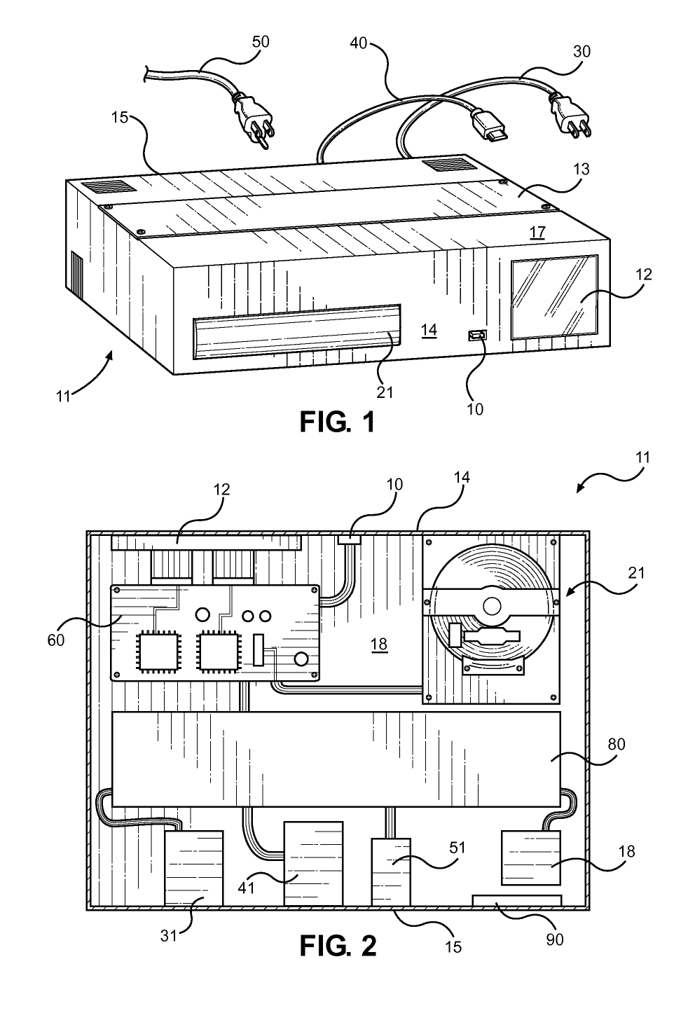

Referring now to FIG. 1, there is shown a frontal perspective view of an exemplary embodiment of the media system of the present invention. The media system is an assembly that allows a user to power a television for a period of time and send media to the television during a power outage. The system offers a source of entertainment during a period of no domestic electricity. The components of the system are supported within a housing 11, whereby the user connects the system to a television and the system transmits signals from a media source and to the television for audio and visual entertainment. Media is received from one or more sources and transmitted as audio and video signals to the television. The two primary media sources include an optical drive and a serial bus connection.

In a preferred configuration, the housing 11 includes a front surface 14, an upper surface 17, a rear surface 15, and a base. Along the front surface 14 is disposed the optical drive tray 21, which extends from the front surface to support an optical disk. These include DVD, CD, and Blu-ray disks that have audio and visual content thereon. The optical drive reads the disks and the system sends signals to an electrically coupled television by way of one or more low voltage cables. The low voltage cables connect to a media signal interface along the rear surface 15 of the housing, whereby the media signal interface comprises one or more different style connectors for low voltage audio and video wires. Some contemplated connectors along the media signal interface include an HDMI (High-Definition Multimedia Interface) connector, component connectors, S-video, and optical connectors.

Also disposed along the front surface 14 of the preferred housing is a display screen 12 and a serial bus connector 10. The display screen 12 is a digital screen that provides the user with visual feedback with regard to the media content being displayed. This may include elapsed playback time, track number, data related to the content being displayed (track name, etc.), or any other alphanumeric or symbolic messages that may be deemed necessary to show to the user. The display screen is preferably minimalistic and draws minimal electrical current, thereby preserving the power of the battery pack within the housing for its primary goals: powering a television and transmitting media to the television.

Along the rear surface 15 of the housing 11 are a plurality of connectors for powering the battery pack and for connecting the media system to a television. A power cord 30 is connected to a power cord connector along the rear surface, whereby the power cord 30 provides electrical power that is transformed into DC power to recharge the battery pack. Low voltage media cables 40 connect to the media signal interface and include HDMI cables 40, component cables, optical cables and the like. Finally, an electrical socket is provided to couple the television power cord 50 to the media system. The television power cord 50 secures to the socket and AC electrical power from an inverter is provided to power the television, whereby the battery pack is providing the electrical power in the event of a power outage. While the wall power is still available, the AC power is used by the media system to recharge the battery and prevent overdischarge or low battery levels during power outages.

The battery pack is accessible through a removable lid 13 along the upper surface 17 of the housing, whereby the battery pack can be interchanged and replaced when necessary. This is useful when charging multiple battery packs, while maintaining several in reserve for prolonged power during an outage. One or more of the battery packs can be removed and replaced when the battery packs eventually drain during the outage, thereby extending the operational time of the media system during the outage.

Referring now to FIG. 2, there is shown an overhead view of the media system, whereby the upper surface of the housing is removed. Within the housing 11 there are one or more battery packs 80 that take up a majority of the interior volume of the housing and are supported by the lower surface 18 of the housing. The battery packs 80 provide electrical power to power a television of moderate size and for a given duration during a power outage, while simultaneously powering the media system within the housing. The media system comprises an optical rive 21, a display 12, a serial bus connector 10, and a processor 60 that controls the serial bus connection and acts as an optical drive controller. The optical drive 21, serial bus connector 10 (e.g. USB connector), and the display 12 are preferably disposed along the forward surface 14 of the housing.

In conjunction with the media system elements, the housing 11 further supports a battery controller 18, which is in connection with the battery packs 80 to control the charging and discharging thereof. Along the rear surface 15 of the housing are disposed various connections for receiving charging power, for distributing battery power, and for sending media signals from the media system. Specifically, an inverter 51 is provided for receiving the power plug of a television therein. The inverter transforms the DC current of the battery packs 80 to AC power, which is used to power the television. Further provided is a rectifier and recharging plug connector 31, which is used to connect the battery packs 80 to domestic power when available for recharging the battery packs. The rectifier 31 transforms the AC power into DC power, while the battery controller 18 controls the battery recharging and ensures the batteries do not overheat or charge/discharge too rapidly. One or more fans 90 may also be disposed along the housing to maintain the batteries in a cool environment while in use.

The battery pack 80 comprises one or more sets of removable battery packs that are design to operate a television and the media system for a period of several hours during a power outage. The duration of available power will depend on the power requirements of the television, which will vary depending on several factors. These include the screen technology of the television (e.g. plasma, LCD, LED, etc.), the size of the television (generally measured by the diagonal length), the brightness settings of the television being watched, and the efficiency of the television. It is contemplated that instructions will be given to the user of the media system of the present invention, which would guide users to employ medium to small televisions and using settings that require less power (i.e. dimmer display settings). Typical power consumption of medium sized flat panel televisions (e.g. 20 inch to 40 inch screen size) ranges between 50-200 Watts, with LCDs being on the lower end and plasma screens being on the higher end. Larger televisions can exceed 200 Watt-hours.

It is desired to provide, at a minimum, a battery pack 80 and housing 11 sized to power a medium sized television for 3-5 hours. Therefore, the battery pack 80 should be sized to provide 400-600 Watt-hours at the required amperage of the television (generally 3-5 amps). To fulfill this power requirement, the batteries are preferably lithium-ion batteries aligned in series to provide sufficient wattage. It is preferred that the batteries exceed the power expectation of the television, as there are efficiency losses in the inverter 51, and the battery must power the media system components of the assembly at the same time as powering the television. It is recognized that the battery pack 80 provides a short duration power source during a power outage. Therefore, the battery packs 80 are removable and replaceable, in the event the user wishes prolonged television entertainment using replacement battery packs. It is further recognized that the duration of the battery pack will be significantly influenced by the type of television employed by the user, therefore more efficient screen technologies are preferred (i.e. LED screens).

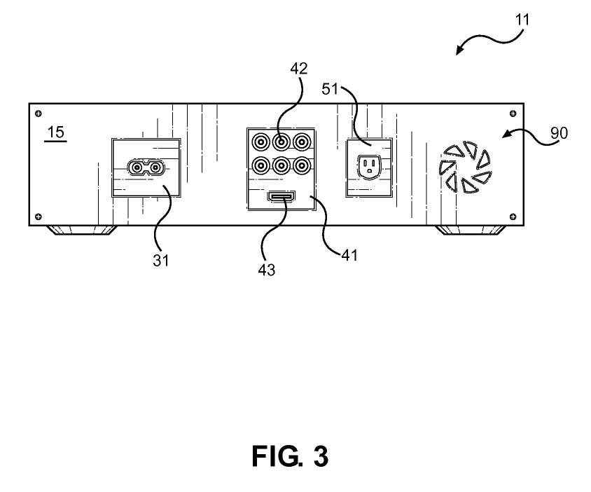

Referring to FIG. 3, there is shown a rear view of the media system of the present invention. The rear surface 15 of the housing 11 provides connections for incoming power, outgoing power, and low voltage media connections. Specifically, a power cord connector 31 is provided to connect a power cord to the media system. The power cord connects to the rectifier and the battery controller, which is used to recharge the batteries. Adjacent to the power cord is the media signal interface 41, which provides low voltage connectors for sending media signals to a television or speaker system. These include HDMI connections 43, component connections 42, S-video, optical connection, and the like. Adjacent to the media signal interface 41 is the television electrical socket 51, which receives the power cord of the television therein. The electrical socket 51 connects to the inverter and receives power from the battery pack. Finally, fans 90 and apertures in the housing may be provided to cool the assembly while in use.

Overall, it is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A media system for powering and transmitting signals to a television during a power outage, comprising:
a housing having a front surface, a rear surface, an upper surface, and a base;
an optical drive and optical drive controller;
a battery pack comprising a plurality of rechargeable batteries;
an electrical socket along the rear surface of the housing that is adapted to receive a power plug of a television therein;
a battery controller;
an inverter between the battery pack and the electrical socket;
a power cord extending from the housing and electrically coupled to the battery pack for recharging the battery pack;
a rectifier between the power cord and the battery pack;
a media signal interface along the rear surface of the housing, whereby audio and video signals are transmitted between the optical drive controller and the television coupled to the video signal interface.

2. The media system of claim 1, wherein the battery pack comprises one or more battery packs that are removable from the housing.

3. The media system of claim 1, wherein the front surface of the housing further comprises a display screen.

4. The media system of claim 1, further comprising:
a processor, a memory, and a serial bus connector adapted to receive data from a serial connection and for transmitting the data to the television via the video signal interface.
